(19) United States
(12) Patent Application Publication
(10) Pub. No.: US 2014/0040307 A1
(43) Pub. Date: Feb. 6, 2014

(54) SOFTWARE DOWNLOADS FROM SEARCH RESULTS PAGE

(71) Applicants: Praveen Kumar Kavety Loganathan, Hyderabad (IN); Subrata Roychoudhuri, Hyderabad (IN); Kartik Poddar, Hyderabad (IN); Mythreyee Devi Ganapathy, Hyderabad (IN); Gaurav Khandelwal, Hyderabad (IN)

(72) Inventors: Praveen Kumar Kavety Loganathan, Hyderabad (IN); Subrata Roychoudhuri, Hyderabad (IN); Kartik Poddar, Hyderabad (IN); Mythreyee Devi Ganapathy, Hyderabad (IN); Gaurav Khandelwal, Hyderabad (IN)

(73) Assignee: MICROSOFT CORPORATION, Redmond, WA (US)

(21) Appl. No.: 13/567,068

(22) Filed: Aug. 5, 2012

(51) Int. Cl. G06F 17/30

(52) U.S. Cl. 707/769; 707/E17.014

(57) ABSTRACT

The disclosed subject matter is generally related to including a download option of a software module from within a search results page. In response to receiving a search query from a user, search results responsive to the search query are identified. The search query is analyzed to detect an intent to download a software module. If an intent to download a software module is detected, a search results page is generated from the search results and further includes a user-actionable control for initiating a process for downloading a corresponding software module to a target computer associated with the user.

### BACKGROUND

While some software is still distributed to users by way of a physical device (e.g., magnetic or optical disks, USB drives, and the like), a sizeable amount of software is now distributed via online downloading, i.e., downloading software over a network. In this environment, when a user seeks to obtain software, the user (via the user's computer) will typically access a network site, such as a Web or Internet page, and initiate a download from that site (or a related site) to the user's computer.

With the proliferation of “apps,” including Web and mobile phone apps, it is very difficult for a user to know which software is the best available in any given situation. Or which version of an app is needed given the computer on which the user is making the request. The user may find it difficult to differentiate between a legitimate software module and malware. Even when the user knows precisely which software module and version is sought, the user is faced with a difficult task of knowing where (i.e., which URL/URI) to obtain the download.

Search engines have proven useful in assisting the user in finding the right app (or several apps that would satisfy the criteria specified by the user to the search engine) and presenting the user with options for obtaining the same. Yet, the process is less that optimal: the user enters a search query, reviews the results that satisfy the query, selects a likely candidate, navigates/hyperlinks to the candidate URL site, and if that site hosts the software module that the user is seeking, the navigates the candidate URL site to ultimately download the software to the user's device (whether it is a handheld device, a portable computer, a desktop computer, and the like).

### SUMMARY

This Summary is provided to introduce a selection of concepts of the disclosed subject matter in a simplified form. These concepts are further described below in the Detailed Description. This Summary is not intended to identify key features or essential features of the claimed subject matter, nor is it intended to be used to limit the scope of the claimed subject matter.

The disclosed subject matter is generally related to including a download option of a software module from within a search results page. In response to receiving a search query from a user, search results responsive to the search query are identified. The search query is analyzed to detect an intent to download a software module. If an intent to download a software module is detected, a search results page is generated from the search results and further includes a user-actionable control for initiating a process for downloading a corresponding software module to a target computer associated with the user. Upon detection of activation of the user-actionable control within the search results page, a download process is initiated that downloads the corresponding software module to a target computer associated with the user.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a pictorial diagram illustrating an exemplary network environment suitable for implementing aspects of the disclosed subject matter;

FIG. 2 is a block diagram illustrating an exemplary routine for providing a search results page, in response to a search query from a user, that includes at least one option for downloading a software module to the user's computer;

FIGS. 3A and 3B are pictorial diagrams illustrating an exemplary browser view of a search results page, each of which includes an option for downloading a software module to a user's computer;

FIG. 4 is a block diagram illustrating an exemplary routine for downloading a software module to the user's computer from a search results page;

FIG. 5 is a pictorial diagram illustrating an exemplary browser view of a search results page that includes an option for downloading a software module to another computer;

FIG. 6 is a block diagram illustrating an exemplary routine for locating software modules on a network (such as the Internet) that can be downloaded to a user's computer; and

FIG. 7 is a block diagram illustrating various components of a search engine configured to provide a search results page in response to a search query, where the search results page includes an option for downloading a software module to a user's computer.

### DETAILED DESCRIPTION

For purposed of clarity, the use of the term “exemplary” in this document should be interpreted as serving as an illustration or example of something, and it should not be interpreted as the ideal and/or leading illustration of that thing.

For purposes of clarity, a “search result” is data presented to a user in response to a search query from the user. Typically, a search result is a reference (or hyperlink) to content accessible to the user over a network, such as the Internet. A “search results page” is a displayable collection of information generated by a search engine in response to a search query. A search results page will typically include one or more search results. One or more search results pages may be generated in response to a single search query from a computer user. As will be discussed further, according to aspects of the disclosed subject matter, when an intent to download a software module is detected in a user's search query, a suitably configured search engine will include an option for downloading a software module that satisfies the download intent of the user in one or more search results pages.

For purposes of clarity, a “software module” corresponds to any of a number computer-executable modules related to execution. These software modules include, but are not limited to, software applications and/or programs; apps (lightweight software applications that are generally focused to a single task), including Web apps, mobile phone apps, and hand-held device apps; service modules including operating system services and daemons; device drivers; executable libraries; scripts; service frameworks; certificates; signatures; and the like.

In regard to the user-actionable control that initiates the downloading of a software module to the user's computer, while examples in the figures and description below suggest the user-actionable control for downloading a software module to a computing device is a clickable button (i.e., though the use of a mouse or other pointing device/mechanism), this is illustrative of one particular user-interaction paradigm and should not be construed as limiting upon the disclosed subject matter. Its use in throughout this description is for illustration purposes only. User-actionable controls also include, but are not limited to, voice activated controls, touch-based controls (including touch, circling and/or other gesture based controls), other natural user interface (NUI) controls, and the like.

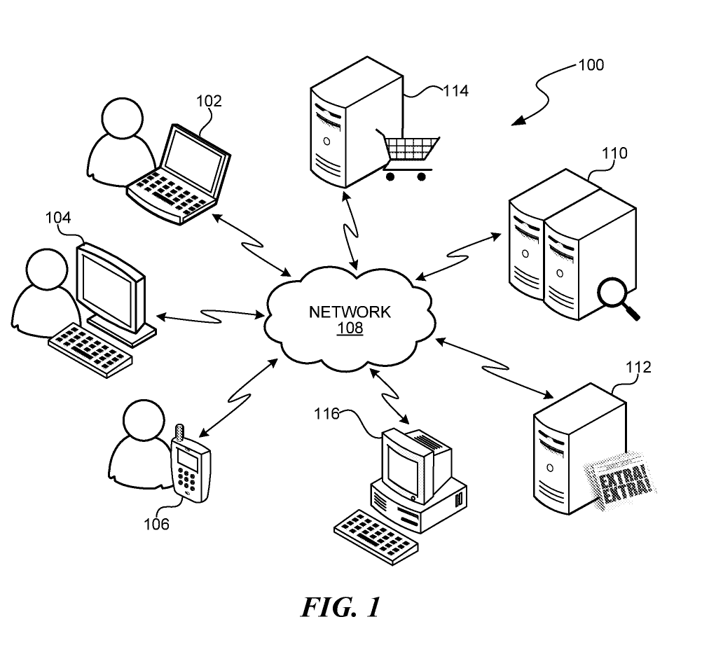

Turning now to the figures, FIG. 1 is a pictorial diagram illustrating an exemplary network environment 100 suitable for implementing aspects of the disclosed subject matter. The illustrative environment 100 includes one or more user computers, such as user computers 102-106, connected to a network 108, such as the Internet, a wide area network or WAN, and the like. Also connected to the network 108 is a search engine 110 configured to provide search results in response to a computer user's search query, including an option to download a software module upon detecting a user's intent to obtain/download the software.

Those skilled in the art will appreciate that a search engine 110 corresponds to an online search service hosted on one or more computers on, or computing systems distributed throughout, the network 108. Generally speaking, the search engine 110 is configured to receive and respond to search queries submitted over the network 108 from various users, such as the users connected to user computers 102-106. As already mentioned, in response to receiving a search query, the search engine 110 obtains search results information related and/or relevant to a user's search query (as defined by the terms of search query.) The search results are typically references (largely in the form of hyperlinks) to relevant/related content available from various target sites (such as target sites 112-116) on the network 108. The search results may also include other information such as, by way of illustration and not limitation, related and/or recommended alternative search queries, data and facts regarding the subject matter of the search query, products, and/or services related/relevant to the search query, and the like. According to aspects of the disclosed subject matter, when a use's intent to obtain or download software is detected in the search query, the search results may also include one or more user controls for initiating the download of a software module that satisfies the download intent detected in the search query.

As those skilled in the art will appreciate, target sites, such as target sites 112-116, host content that is available and/or accessible to users (via user computers) over the network 108. Often, the hosted content will include software modules that are available to be downloaded to a user's computer. As will be described in greater detail below, the search engine 110 discovers this content (including the software modules) generally through a “crawling” process across the network 108 and, upon discovery of the content, will store information regarding the same for later access. As shown in FIG. 1, the target sites include, by way of illustration, a news organization 112, a shopping site 114, and an online music service 116. Each of these target sites 112-116 may include one or more software modules that can be downloaded to a user's computer or computing device. Of course, these are illustrative only and those skilled in the art will appreciate that any number and type of target sites may be connected to the network 108. Moreover, as is known in the art, some search engines are aware of millions of target sites, any one of which may make available one or more software modules.

In addition to offering search services, search engines may also make software modules available for downloading. For example, search engine 110 may also offer a mobile phone app for the purpose of conducting searches on the user's mobile phone (i.e., without opening a browser and navigating to the search engine 110.) Further still, while target sites, including target sites 112-116, may offer one or more software modules for downloading, it should be appreciated that the software modules may or may not be owned by or specific to the target site. While not shown, some target sites offer a centralized service where users can look to find software modules for downloading. These target sites make the software modules available to the user for downloading.

Suitable user computers for operating within the illustrative environment 100 include any number of computing devices that can communicate with the search engine 110 or target sites 112-116 over the network 108. In regard to the search engine 110, communication between the user computers 102-106 and the search engine 110 include both submitting search queries and receiving a response in the form of one or more search results pages from the search engine 110. User computers 102-106 may communicate with the network 108 via wired or wireless communication connections. These user computers 102-106 may comprise, but are not limited to: laptop computers such as user computer 102; desktop computers such as user computer 104; mobile phone devices such as user computer 106; tablet computers, including mobile tablet computers (not shown); on-board computing systems such as those found in vehicles (not shown); mini- and/or main-frame computers (not shown); and the like. Common to all of these computing devices is a processor configured to execute instructions from a memory, user interface components, as well as a communication component enabling the computing device to communicate with other computers over the network 108.

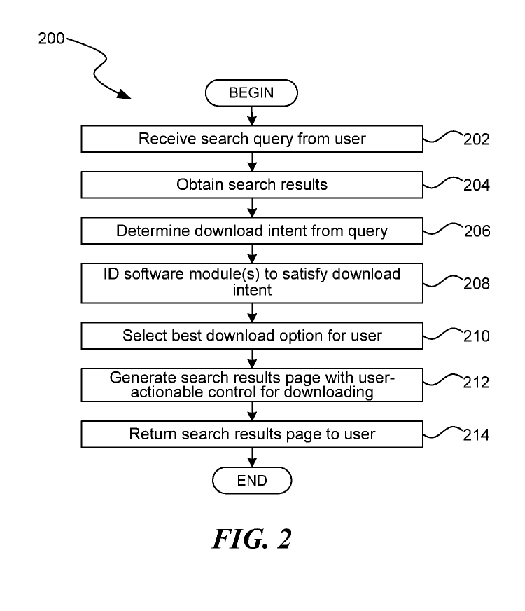

Turning now to FIG. 2, this figure shows a block diagram illustrating an exemplary routine 200 for providing a search results page in response to a search query from a user that includes at least one option for downloading a software module to the user's computer. Beginning with block 202, a search engine 110 receives a search query from a user. At block 204, search results responsive to the search query are obtained. At block 206, an analysis is performed on the search query (and potentially on the search results previously obtained) to determine/identify a download intent, i.e., that the computer user (who submitted the search query) is potentially looking for a software module to download to the user's computer.

Once a download intent is determined, a corresponding software module that satisfies the download intent is identified. The software module is identified according to the subject matter of the search query as well as contextual information relating to the user. For example, assume that the search query submitted to the search engine 110 is “compression software.” In addition to obtaining a set of search results for the search query, a download intent detection component determines that the search query exhibits sufficient download intent that the search engine could also include a download option among the search results. Since “compression software” is fairly broad in scope and may encompass many different software packages, the search engine 110 can turn to contextual information to determine which compression software module (or modules) would be most likely to satisfy the user's download intent. This context information may include, but is not limited to, the specific computing device to which the software module will be downloaded, processor type, processor data-path size (e.g., 64 bit vs. 32 bit), operating system and revision, language modules, current software already on the user's computing device, geography, reliability and/or reputation of the software module, communication and/or download bandwidth, and the like. In addition to contextual information related to the computer/computing device, user profile information may also be considered including, but not limited to, explicit or implicit preferences and requirements; related software modules on other computers operated by the user; preferences/requirements of the user's social groups; and the like. Through consideration of various combinations of this information the search engine 110 identifies a software module that best satisfies the download intent determined from the search query.

As those skilled in the art will appreciate, for any given software module there may be numerous download sites from which the software module may be obtained. Thus, at block 210, the search engine 110 selects the best download option for the user to obtain the identified software module (or software modules). In selecting a best download option for the user, the search engine 110 may consider information such as proximity of the user's computing device to a target site (where the software module may be downloaded), available bandwidth of a target site, reliability and/or security of a target site, and the like. According to at least one embodiment, the software module may be hosted by and downloaded from the search engine (acting as a target site.)

After selecting the best download option for the user, at block 212 the search engine 110 generates a search results page that includes at least one user-actionable control for downloading a software module that satisfies the download intent of the user. The user-actionable control is configured such that, rather than navigating to another network location to download the software module, upon activation of the control a process is begun that downloads the software module to the user's computing device. After generating the search results page, at block 214 the search engine 110 returns the search results page to the user for display and/or presentation to the computer user. Thereafter, the routine 200 terminates.

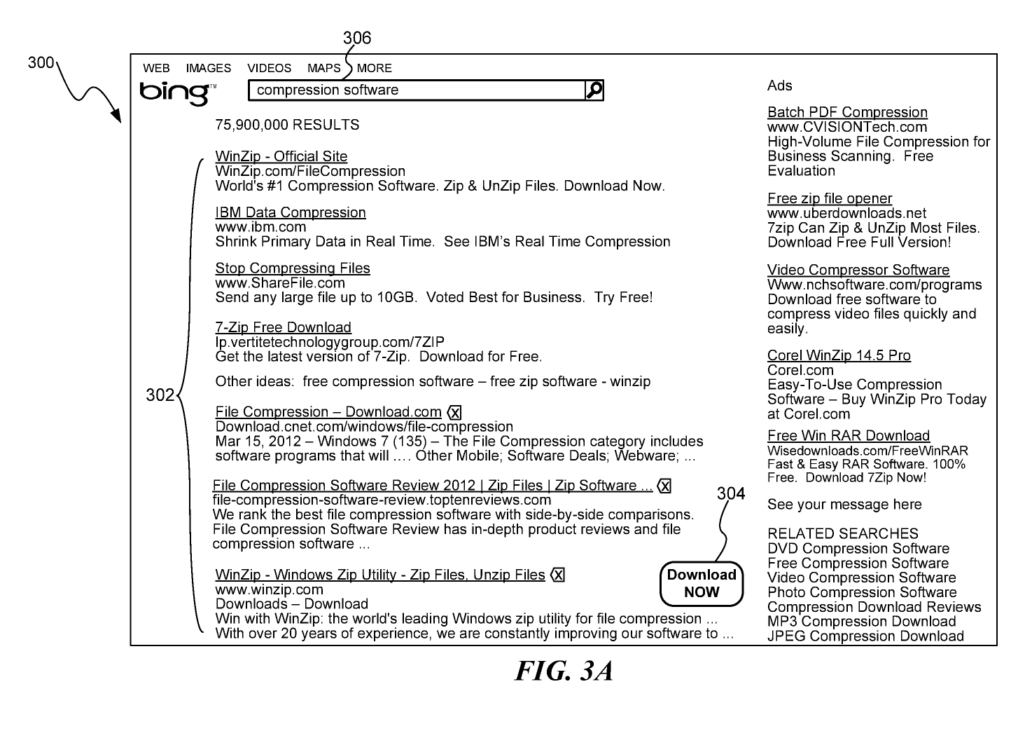

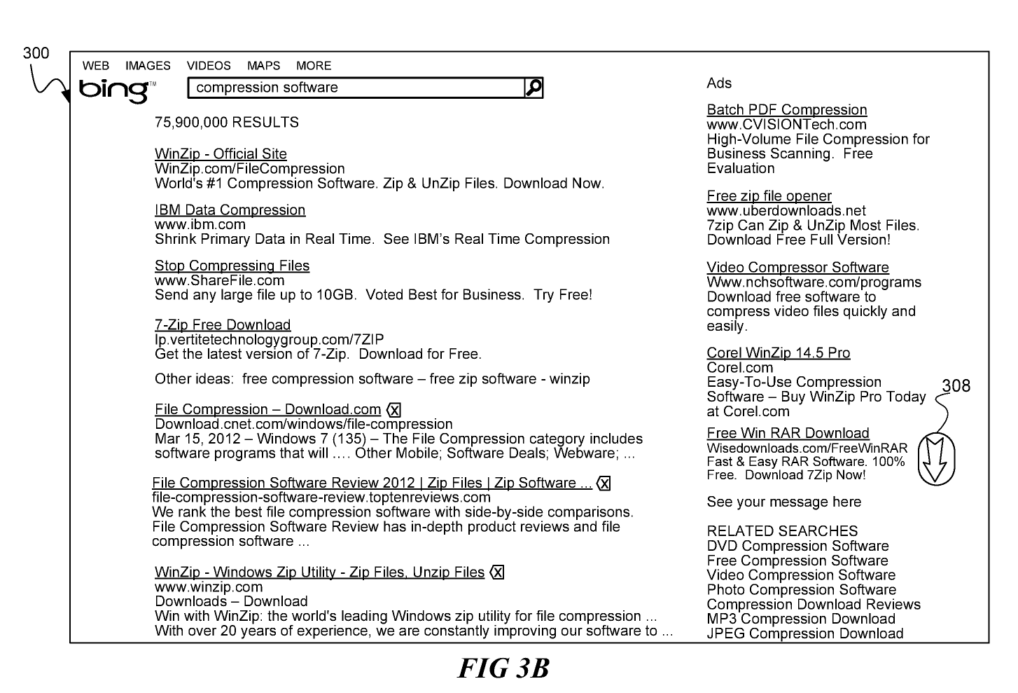

To further illustrate the inclusion of a user-actionable control for downloading a software module in a search results page, FIGS. 3A and 3B are pictorial diagrams illustrating browser views of search results pages that include an option for downloading a software module to a user's computer. As shown in FIG. 3A, the browser view 300 includes search results 302 that were selected by a search engine 110 as being responsive to the search query 306, “compression software.” The browser view 300 includes a user-actionable control 304 for initiating the process to download a software module (the “WinZip” utility) to the user's computer. As shown in the illustrative browser view, the user-actionable control 304 is placed in proximity to the corresponding search result, thereby indicating what will be downloaded to the user's computing device. However, in an alternative embodiment (now shown), the user-actionable control for downloading a may be located anywhere on the search results page and the control (or surrounding indicators) will indicate which software module will be installed through activation of the control.

While the user-actionable control 304 in FIG. 3A is associated with one of the search results 302 responsive to a search query, the disclosed subject matter is not so limited. In an alternative embodiment, a download option may be associated with another object on a search results page that is not a “search result.” For example, FIG. 3B illustrates the same search results page of FIG. 3A, but in this alternative embodiment the download option, as indicated by user-actionable control 308, is associated with an advertisement. In this embodiment, the search engine 110 determined that the best product to download may be the product associated with the advertisement.

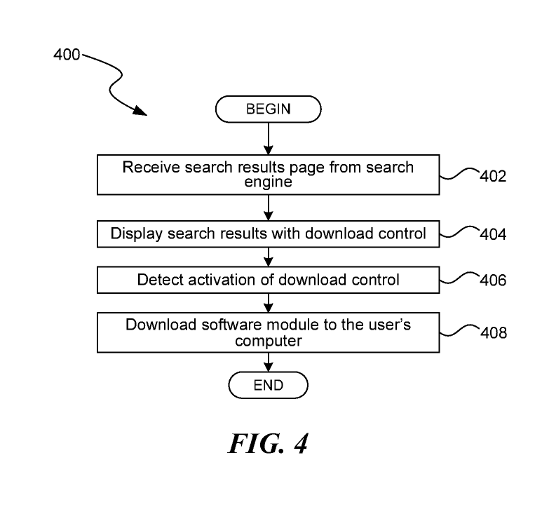

Regarding user activation of the user-actionable control (such as control 304 of FIG. 3A), FIG. 4 is a block diagram illustrating an exemplary routine 400 for downloading a software module to the user's computer from a search results page, such as the search results page displayed in the browser view 300 of FIG. 3. Beginning at block 402, a search results page responsive to a search query is received at the user's computer from a search engine 110. At block 404, the search results page, which includes a user-actionable control for initiating the process to download a software module to the user's computer, is displayed. At block 406, user activation of the user-actionable control is detected. At block 408, upon detecting user activation of the user-actionable control, a process is begun to download the software module associated with the user-actionable control to the user's computer.

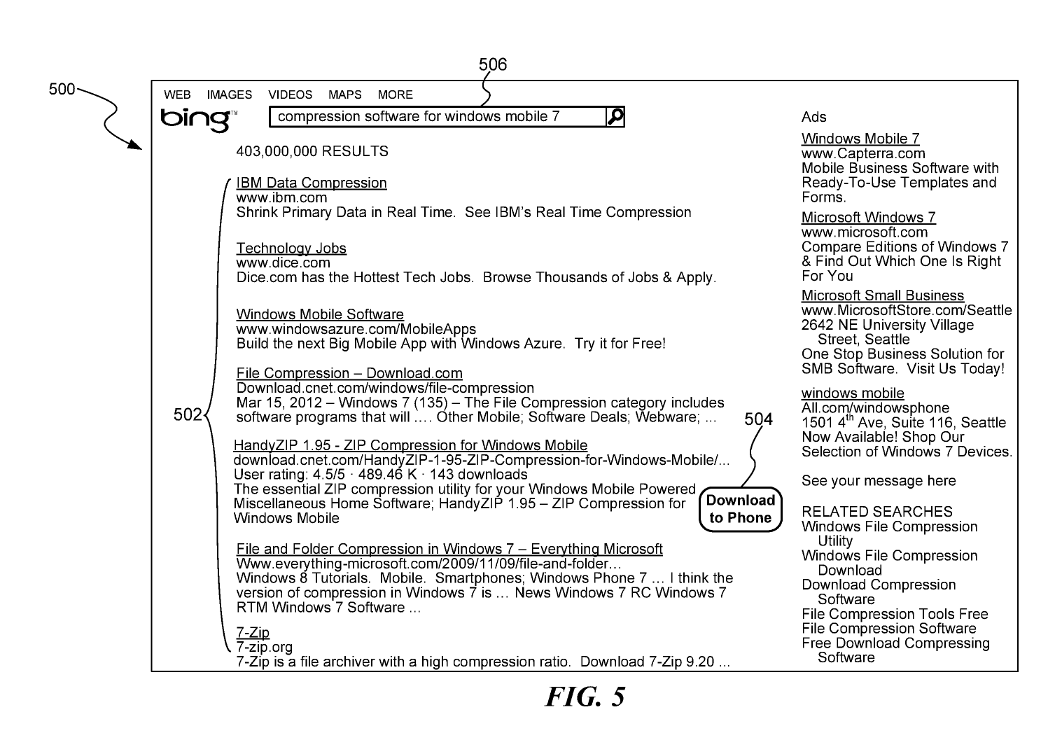

While much of the discussion thus far has been in regard to downloading a software module to the computer upon which the user is currently operating, the disclosed subject matter is not so limited. In an alternative embodiment, the particular download intent of a user may be to obtain software for another computing device. For example, a computer user on a desktop computer may be searching for a software module to be installed on the user's mobile phone. FIG. 5 is a pictorial diagram illustrating an exemplary browser view 500 of a search results page that includes an option for downloading a software module to another computer, other than the computer that the computer user is currently engaged with. As can be seen, in this example the user has submitted the search query 506 “compression software for windows mobile 7.” Assuming that the current computing device is not a mobile device, the search results 502 correspond generally to compression software for a mobile device and the user-actionable control 504 represents an opportunity to download the corresponding software module to the user's mobile phone. Of course, downloading to the user's mobile phone requires that the search engine have information regarding the user's mobile and how to download the software to that device.

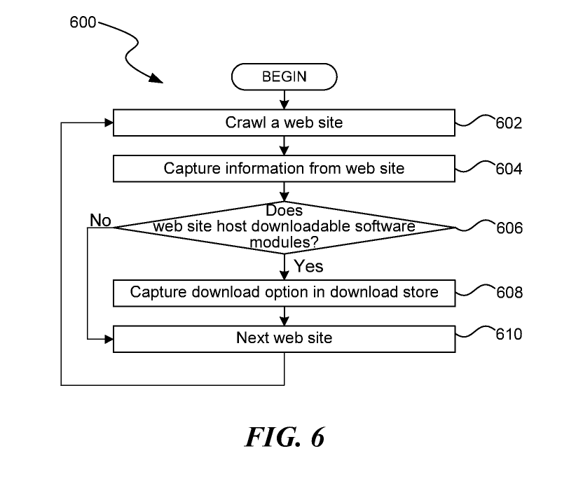

In order to enable downloading software modules from a search results page, the search engine 110 generally needs information regarding the source (or sources) of the various software modules. This information can be gained, at least in part, in crawling the network 108. Crawling the network 108 to identify content for inclusion in a search engine's content index is known to those skilled in the art. However, this crawling procedure can be extended to capture information for identifying available software modules that can be downloaded to a user's computer. To this end, reference is made to FIG. 6 that shows a block diagram illustrating an exemplary routine 600 for locating software modules on a network 108 (such as the Internet) that can be downloaded to a user's computer. Beginning at block 602, a process (sometimes referred to as a “web crawler” or a “spider”) crawls a web site. “Crawling” a website (or URL) is the process of visiting networked sites (URLs or URIs) in a planned, automated fashion to obtain the latest information from that site. Thus, at block 604, the information at the current web site is captured into the search engine's content index. As part of capturing the content at the current web site, at decision block 606 a determination is made as to whether the content on the web site includes downloadable software modules. If so, at block 608 the information relating to the downloadable software modules is captured in a download store maintained by the search engine 110. Thereafter, of if no downloadable software modules were detected in the content, the routine 600 proceeds to block 610 were a next web site is selected for crawling. The routine 600 then returns to block 602 and repeats the process.

Crawling the network 108 for content is typically an on-going process as the content on a given network, such as the Internet, is constantly being updated and added upon. Hence, while a crawling process (such as the one described in routine 600) may possibly terminate, a logical view of the process is that it is one that continues to operate. Accordingly, while it should not be construed as limiting on the disclosed subject matter, routine 600 does not include a termination to the routine.

As those skilled in the art will appreciate, routines or methods, such as routines 200, 400, and 600, are described in terms of steps to carry out the functionality of the disclosed subject matter. It should be appreciated, however, that the steps identified in these routines are logical steps and may or may not correspond to actual steps carried out in an actual implementation of the disclosed subject matter. Moreover, those skilled in the art will appreciate that the individual steps, themselves, are often comprised of many discrete instructions. On a suitably configured computer or computing device, these instructions are retrieved from a memory/instruction store and executed by a processor. Execution of these instructions may or may not be carried out in conjunction with other physical and/or logical components of the computer.

While various aspects of the disclosed subject matter are expressed as steps in routines or methods, the functionality of these various aspects may also be embodied in computer-readable media. As those skilled in the art will appreciate, computer-readable media (also referred to as computer-readable storage media and/or a computer program product) can host computer-executable instructions for later retrieval and execution, including instructions for carrying out the functionality of the subject matter disclosed in this document. When executed by a processor on a computing device, the computer-executable instructions carry out various steps or methods. In this regard, computer-readable media may serve as the memory/instruction store mentioned above. Examples of computer-readable media include, but are not limited to: optical storage media such as digital video discs (DVDs) and compact discs (CDs); magnetic storage media including hard disk drives, floppy disks, magnetic tape, and the like; memory such as random access memory (RAM), read-only memory (ROM), memory cards, thumb drives, and the like; cloud storage (i.e., an online storage service); and the like. While it is possible to execute instructions obtained via carrier waves and/or propagated signals, for purposes of this document, computer-readable media expressly excludes carrier waves and propagated signals.

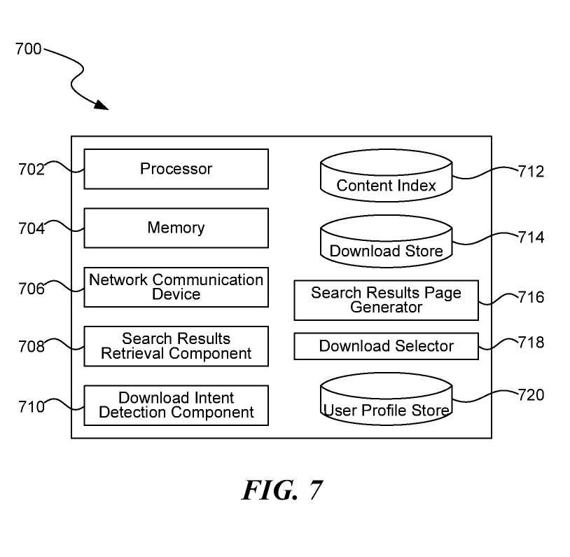

Turning now to FIG. 7, this figure shows a block diagram illustrating various components of a search engine 110 configured to provide a search results page in response to a search query, where the search results page includes a user-actionable control for downloading a software module directly to a user's computer. As shown, the exemplary search engine 110 includes a processor 702 and a memory 704. As those skilled in the art will appreciate, the processor 702 executes instructions retrieved from memory 704 in carrying out various aspects of the search engine service, including responding to search queries with one or more search results pages, including at least one search results page that includes a user-actionable control for downloading a software module directly to the user's computer (or computing device.)

The search engine 110 also includes a network communications component 706 through which the search engine 110 sends and receives communications over the network 108. For example, it is through the network communication component 706 that the search engine 110 receives search queries from users in the user computers, such as user computers 102-106, and returns one or more search results pages responsive to the search queries. The search engine 110 also includes additional components such as, but not limited to: a search results retrieval component 708; a download intent component 710; a content index 712; a download store 714; a search results page generation component 716; a download selector component 718; and a user profile store 720. Regarding these additional components, it should be appreciated that these should be viewed as logical components for carrying out various functions of suitable configured search engine 110. These logical components may or may not correspond directly to actual and/or physical components. Moreover, in an actual embodiment, these components may be combined together or broke up across multiple actual components.

The search results retrieval component 708 retrieves and/or obtains search results relevant to a user's search query from the content index 712. The content index 712 is something of a misnomer in that for some embodiments of the search engine 110 the context index typically stores references to content, not the content itself. However, the content index 712 is not limited to storing just references to content and may also store the actual content.

The download intent component 710 is used to analyze the user's search query to determine/detect the download intent of the user such that a corresponding user-actionable control to download a software module to the user's computing device can be included in the generated search results page. The search results page generator 716 generates one or more search results pages from the search results obtained by the search results retrieval component 708, and includes user-actionable controls (as well as the necessary underlying instructions) to download a software module to the user's computing device when there is a download intent (as determined by the download intent detection component 710).

The download selector component 718 identifies the software modules to be downloaded to the user computer from information in the content store 714. As indicated earlier, the download selector may rely upon contextual information about the user's computer (both implicit and explicit contextual information) and upon user profile information in the user profile store 720. Of course, while the software modules to be downloaded may be stored in the content store 714, they need not be stored within the content store. Instead, information regarding the location of the software modules as well as information as to how to download the software modules may be stored in the content store 714.

As previously mentioned, when a download intent is identified/determined from a user's search query, the search engine 110 (through components such as, but not limited to, the download intent detection component 710 and the download selector component 718) selects a software module that may be downloaded to the user's current computing device or an alternative computing device associated with the user (such as the user's mobile phone, tablet device, laptop computer, and the like.) The particular selection of software module to be downloaded may be based on contextual information that includes, but is not limited to, popularity of a software module; reputation for quality, security, and/or functionality of a software module or it's provider; availability of support for a software module (either from the provide or from a community); demographic information of the user (e.g., users of a particular demographic prefer to user software brand “X”); implicit and/or explicit user preferences for a particular brand; default languages employed on the target computer/device (i.e., the device for which the software module is intended); geographic location of the target computer/device; proximity of the target computer/device with regard to the repository (hosting site) of the software module; download bandwidth and/or available download bandwidth of a hosting site; processor type of the target computer/device; operating system deployed on the target computer/device; software modules already deployed on the target computer/device; and the like. Moreover, in at least some cases there may be multiple sources (i.e., hosting sites) from which a particular download may be available. In such cases, the download selector will choose a hosting site according to several of the criteria including, but not limited to, bandwidth and/or current bandwidth usage of the hosting sites; reliability of the hosting sites; and the like.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for responding to a search query from a user, the method comprising:
receiving a search query from a user via the user's computer;
obtaining a set of search results that satisfy the search query;
determining a download intent of the user from the search query;
identifying a software module that satisfies the download intent of the user;
generating a search results page comprising a subset of the obtained search results, and further comprising a user-actionable control to initiate a download of the identified software module to a target computer from the generated search results page; and
returning the generated search results page for presentation to the user responsive to the search query.

2. The method of claim 1, wherein identifying the software module that satisfies the download intent of the user further comprises identifying the software module that satisfies the download intent of the user according to contextual data of the target computer and the user.

3. The method of claim 2, wherein the contextual data comprises demographic data of the user.

4. The method of claim 2, wherein the contextual data comprises the current location of the target computer.

5. The method of claim 2, wherein the contextual data comprises a default language employed on the target computer.

6. The method of claim 2, wherein the contextual data comprises the operating system deployed on the target computer.

7. The method of claim 1 further comprising selecting a download option for downloading the identified software module from a plurality of hosting sites to the target computer.

8. The method of claim 7, wherein selecting the download option for downloading the identified software module to the target computer is made according to the download bandwidth of the plurality of hosting sites.

9. The method of claim 7, wherein selecting the download option for downloading the identified software module to the target computer is made according to the reliability attributed to each of a plurality of hosting sites.

10. The method of claim 7, wherein selecting the download option for downloading the identified software module to the target computer is made according to the proximity of each of the plurality of hosting sites to the target computer.

11. A computer-readable medium bearing computer-executable instructions which, when executed on a computing system comprising at least a processor retrieved from the medium, carry out a method for responding to a search query from a user, the method comprising:
obtaining a set of search results that satisfy a search query received from a user via a user computer;
determining a download intent of the user from the search query;
identifying a software module that satisfies the download intent of the user according to contextual data of a target computer and the user;
selecting a download option from a plurality of hosting sites that host the identified software module for downloading the identified software module to the target computer;
generating a search results page comprising a subset of the obtained search results, and further comprising a user-actionable control to initiate the downloading of the identified software module to the target computer from the generated search results page; and
returning the search results page for presentation to the user responsive to the search query.

12. The computer-readable medium of claim 11, wherein the contextual data comprises demographic data of the user.

13. The computer-readable medium of claim 11, wherein the contextual data comprises the proximity of the target computer to a hosting site.

14. The computer-readable medium of claim 11, wherein the contextual data comprises the available download bandwidth of a hosting site.

15. The computer-readable medium of claim 11, wherein the contextual data comprises the reputation of a hosting site.

16. The computer-readable medium of claim 11, wherein the user computer and the target computer are the same computer.

17. The computer-readable medium of claim 11, wherein the contextual data comprises a default language associated with the user.

18. The computer-readable medium of claim 11, wherein the contextual data comprises the processor type of the target computer.

19. The computer-readable medium of claim 11, wherein the contextual data comprises the operating system deployed on the target computer.

20. A computer-implemented method for processing a search query from a user, the method comprising:
receiving a search query from a user, the search query indicating an intent to obtain a software module for a target computer associated with the user;
obtain a search results pages from a search service comprising a plurality of search results relevant to the search query, and further comprising a user-actionable control proximate to a search result for initiating a download process for downloading a corresponding software module to the target computer associated with the user;
presenting the search results page to the user;
detecting the activation of the user-actionable control; and
initiating the download process for downloading a corresponding software module to the target computer associated with the user.
